(19) United States
(12) Patent Application Publication
(10) Pub. No.: US 2011/0298747 A1
(43) Pub. Date: Dec. 8, 2011

(54) CAPACITIVE TOUCH PANEL

(75) Inventors: Woon Chun Kim, Gyunggi-do (KR); Yong Soo Oh, Gyunggi-do (KR); Jong Young Lee, Gyunggi-do (KR); Jae Il Kim, Gyunggi-do (KR)

(73) Assignee: SAMSUNG ELECTRO-MECHANICS CO., LTD., Gyunggi-do (KR)

(21) Appl. No.: 12/887,673

(22) Filed: Sep. 22, 2010

(30) Foreign Application Priority Data
Jun. 4, 2010 (KR) 1020100053038

(51) Int. Cl. G06F 3/044

(52) U.S. Cl. 345/174

(57) ABSTRACT

Disclosed herein is a capacitive touch panel 100 including a first transparent electrode 120 formed on one surface of a first transparent substrate 110, a first electrode wiring 130 formed on the other surface of the first transparent substrate 110, a conductive via 140 penetrating through the first transparent substrate 110 to connect the first transparent electrode 120 to the first electrode wiring 130, a second transparent electrode 160 formed on one surface of a second transparent substrate 150, a second electrode wiring 170 connected to the second transparent electrode 160, and an adhesive layer 180 formed between the other surface of the first transparent substrate 110 and the second transparent electrode 160 so that the other surface of the first transparent substrate 110 is opposite to the second transparent electrode 160.

### CROSS REFERENCE TO RELATED APPLICATION

This application claims the benefit of Korean Patent Application No. 10-2010-0053038, filed on Jun. 4, 2010, entitled “Capacitive touch panel”, which is hereby incorporated by reference in its entirety into this application.

### BACKGROUND OF THE INVENTION

1. Technical Field

The present invention relates to a capacitive touch panel.

2. Description of the Related Art

Alongside the growth of computers using digital technology, devices assisting the computers have also been developed, and personal computers, portable transmitters and other personal information processors execute processing of text and graphics using a variety of input devices such as a keyboard, a mouse and so on.

While the rapid advancement of the information-based society has been widening the use of computers more and more, there have been occurring the problems of it being difficult to efficiently operate products using only the keyboard and mouse as being currently responsible for, the input device function. Thus, a demand for a device that is simple, does not malfunction, and has the capability to input easily is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. Currently, the capacitive type is most prevalently used in a broad range of fields.

FIG. 1 is a cross-sectional view of a capacitive touch panel according to the prior art. Problems of the prior art will be described with reference to the figure.

As shown in FIG. 1, a capacitive touch panel 10 according to the prior art includes an upper substrate 11 on which a first transparent electrode 12 is formed, a lower substrate 13 on which a second transparent electrode 14 is formed, and an adhesive layer 15 that adheres the first transparent electrode 12 to the second transparent electrode 14 opposite to each other. In addition, a first electrode wiring 16 and a second electrode wiring 17 are provided on both ends of the first transparent electrode 12 and the second transparent electrode 14, respectively. Herein, the first transparent electrode 12 and the second transparent electrode 14 serve to sense a user's touch, and the first electrode wiring 16 and the second electrode wiring 17 serve to transfer an electrical signal to a controller.

Meanwhile, the first transparent electrode 12 is generally made of indium tin oxide (ITO), whereas the first electrode wiring 16 is made of silver (Ag). Therefore, an electromigration (EM) phenomenon occurs, the EM phenomenon that electrons move due to potential difference between the first transparent electrode 12 and the first electrode wiring 16 when current flows. Reviewing the electromigration (EM) phenomenon in detail, when current flows on the first transparent electrode 12, numerous electrons move from a cathode to an anode and the electrons collide with metal atoms forming the first transparent electrode 12, such that a momentum exchange is generated. Voids generated by the exhaustion of atoms are formed in the cathode by the momentum exchange to cause a disconnection and a hillock due to the accumulation of atoms are generated in the anode to cause a disconnection, such that the first transparent electrode 12 is modified.

In addition, the capacitive touch panel 10 according to the prior art has a structure in which the first transparent electrode 12 is disposed under the upper substrate 11, but the sensitivity of the first transparent electrode 12 that senses a user's touch is degraded due to the relatively thick upper substrate 11.

In addition, since the first electrode wiring 16 should be provided on both ends of the first transparent electrode 12, the first transparent electrode 12 should be formed except for a bezel region, that is the portion of the upper substrate 11 on which the first electrode wiring 16 is to be formed. Therefore, the first transparent electrode 12 is formed, such that there is a limitation in expanding an active region that actually senses a user's touch.

### SUMMARY OF THE INVENTION

The present invention has been made in an effort to provide a capacitive touch panel that can prevent electromigration (EM) between a transparent electrode and an electrode wiring by adopting a conductive via connecting the transparent electrode to an electrode, and improve sensitivity of the transparent electrode by disposing the transparent electrode on the upper side of a transparent substrate.

A capacitive touch panel according to a preferred embodiment of the present invention includes: a first transparent electrode formed on one surface of a first transparent substrate; a first electrode wiring formed on the other surface of the first transparent substrate; a conductive via penetrating through the first transparent substrate to connect the first transparent electrode to the first electrode wiring; a second transparent electrode formed on one surface of a second transparent substrate; a second electrode wiring connected to the second transparent electrode; and an adhesive layer formed between the other surface of the first transparent substrate and the second transparent electrode so that the other surface of the first transparent substrate is opposite to the second transparent electrode.

Herein, the capacitive touch panel further includes a flexible printed cable of which one surface is connected to the first electrode wiring and the other surface is connected to the second electrode wiring.

Further, the conductive via is made of gold (Au), platinum (Pt), carbons, or a mixture thereof.

Further, the carbons include a carbon nano tube or a carbon nano fiber.

Further, the first transparent electrode is made of a conductive polymer.

Further, the conductive polymer includes poly-3,4-ethylenedioxythiophene/polystyrenesulfonate (PEDOT/PSS), polyaniline, polyacetylene, or polyphenylenevinylene.

Further, both ends of the first transparent electrode correspond to the edges of the first transparent substrate.

The capacitive touch panel further includes a protective layer coating the first transparent electrode.

### BRIEF DESCRIPTION OF THE DRAWINGS

FIG. 1 is a cross-sectional view of a capacitive touch panel according to the prior art;

FIG. 2 is a perspective view of a touch panel according to a preferred embodiment of the present invention;

FIG. 3 is an exploded perspective view of the perspective view of the capacitive touch panel of FIG. 2;

FIG. 4 is a cross-sectional view taken along line A-A′ of FIG. 2; and

FIG. 5 is a cross-sectional view taken along line B-B′ of FIG. 2.

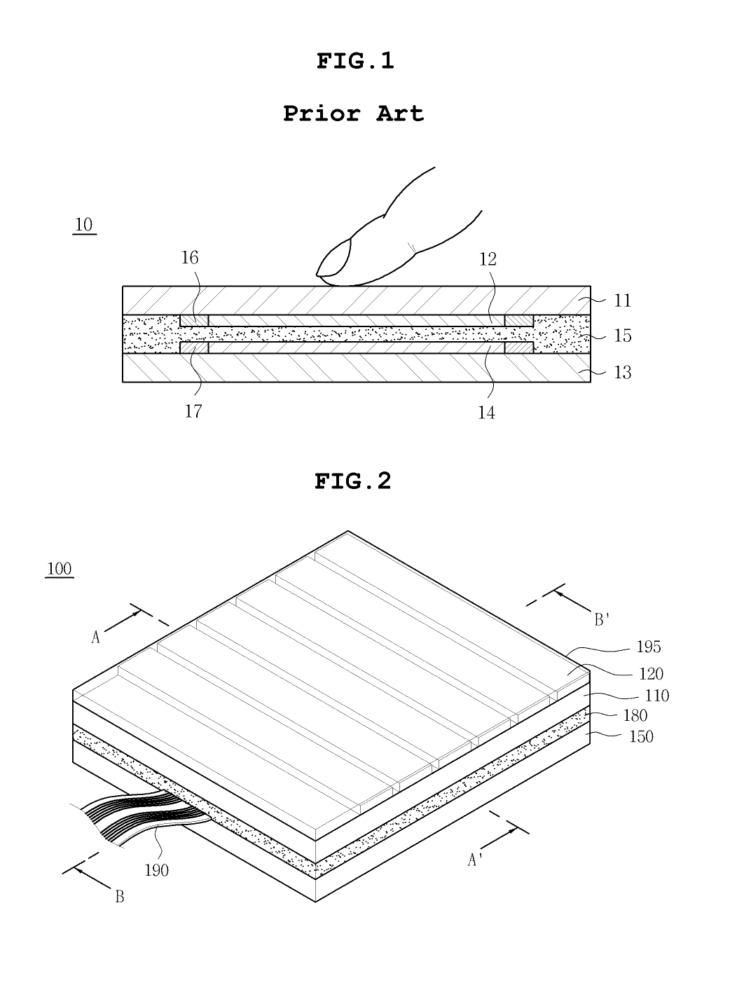

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, and so on are used to distinguish one element from another element, and the elements are not defined by the above terms. Further, in describing the present invention, a detailed description of related known functions or configurations will be omitted so as not to obscure the subject of the present invention.

Hereinafter, preferred embodiments of the present invention will be described in detail with reference to the accompanying drawings.

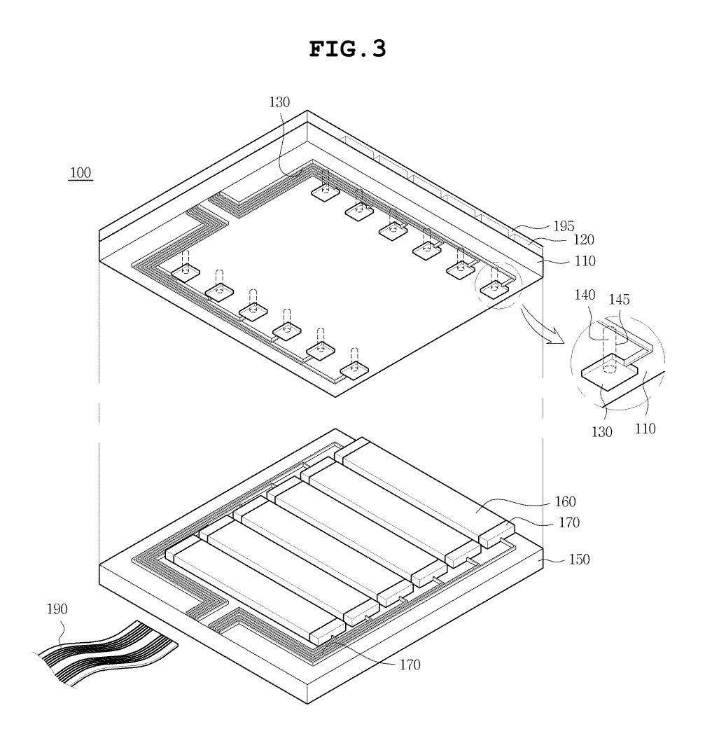

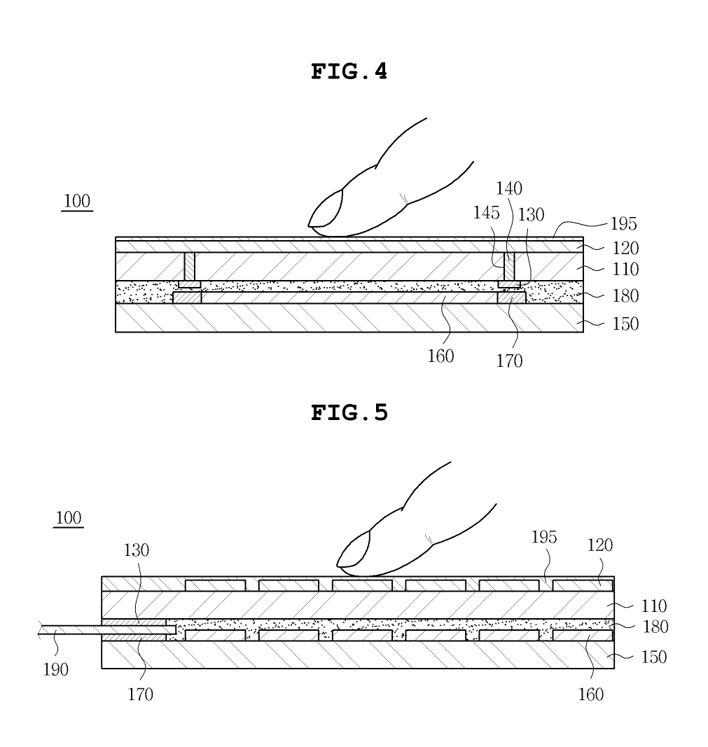

FIG. 2 is a perspective view of a touch panel according to a preferred embodiment of the present invention, FIG. 3 is an exploded perspective view of the perspective view of the capacitive touch panel of FIG. 2, FIG. 4 is a cross-sectional view taken along line A-A′ of FIG. 2, and FIG. 5 is a cross-sectional view taken along line B-B′ of FIG. 2.

As shown in FIGS. 2 to 5, a capacitive touch panel 100 according to the present embodiment is configured to include a first transparent electrode 120 formed on one surface of a first transparent substrate 110, a first electrode wiring 130 formed on the other surface of the first transparent substrate 110, a conductive via 140 penetrating through the first transparent substrate 110 to connect the first transparent electrode 120 to the first electrode wiring 130, a second transparent electrode 160 formed on one surface of a second transparent substrate 150, a second electrode wiring 170 connected to the second transparent electrode 160, and an adhesive layer 180 formed between the other surface of the first transparent substrate 110 and the second transparent electrode 160 so that the other surface of the first transparent substrate 110 is opposite to the second transparent electrode 160.

The first transparent substrate 110 includes the first transparent electrode 120 formed on one surface and the first electrode wiring 130 formed on the other surface thereof, and a penetration hole 145 in which a conductive via 140 connecting the first transparent electrode 120 to the first electrode wiring 130 is formed (see FIGS. 3 and 4). Herein, the material of the first transparent substrate 110 is not particularly limited, and may include polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass and so on.

When there is a user's touch, the first transparent electrode 120 serves to generate a signal together with the second transparent electrode 160 to allow the controller to recognize coordinates. The first transparent electrode 120 is formed on one surface of the first transparent substrate 110 to be disposed on the upper side of the first transparent substrate 110 considering the entire structure of the touch panel (see FIGS. 2 and 3). Therefore, unlike the capacitive touch panel according to the prior art, in the capacitive touch panel 100 according to the present embodiment, the first transparent electrode 120 is disposed on the outside of the first transparent substrate 110, thereby making it possible to improve sensitivity of the first transparent electrode 120. In addition, the first transparent electrode 120 is formed on the opposite surface of the first electrode wiring 130 such that the first electrode wiring 130 is not required to be formed on one surface of the first transparent substrate 110 on which the first transparent electrode 120 is formed. As a result, the area of the first transparent electrode 120 is maximized by corresponding both ends of the first transparent electrode 120 to the edges of the first transparent substrate 110, thereby making it possible to maximally expand the active region through which a user's touch is sensed (see FIG. 2). Meanwhile, the first transparent electrode 120 may be made of a conductive polymer having excellent flexibility and a simple coating process as well as indium tin oxide (ITO) that is commonly used. At this time, the conductive polymer includes poly-3,4-ethylenedioxythiophene/polystyrenesulfonate (PEDOT/PSS), polyaniline, polyacetylene, polyphenylenevinylene, or the like. Further, before forming the first transparent electrode 120 on one surface of the first transparent substrate 110, it is preferable to perform a high frequency treatment or a primer treatment on the surface of the first transparent substrate 110 in order to improve adhesion. Meanwhile, even though the first transparent electrode 120 is shown to have a bar type (see FIG. 3), it is just exemplary but may also be formed to have a diamond shape, a triangular type, an octagonal type, or a circular type.

The first electrode wiring 130 serves to transfer an electrical signal between the first transparent electrode 120 and the controller. The first electrode wiring 130 is formed on the other surface of the first transparent substrate 110 to be connected to the first transparent electrode 120 through the conductive via 140. Herein, the first electrode wiring 130 may be formed using a silk screen method, a gravure printing method, an ink-jet printing method or the like. Further, the first electrode wiring 130 may be made of silver (Ag) paste or organic Ag having superior electrical conductivity, but the present invention is not limited thereto. In addition, a conductive polymer material, carbon black (including CNT), or a low resistive metal including metal or a metal oxide such as ITO may be used. Meanwhile, even though the first electrode wiring 130 is shown to be connected to both ends of the first transparent electrode 120 through the conductive via 140, it is not always limited thereto but may also be connected to only one end of the first transparent electrode 120 according to the scheme of the touch panel. When the first electrode wiring 130 is connected to only one end of the first transparent electrode 120, the conductive via 140 should also be formed on one end of the first transparent electrode 120.

The conductive via 140 serves to prevent electromigration (EM) between the first transparent electrode 120 and the first electrode wiring 130. The conductive via 140 is provided in a penetration hole 145 penetrating through the first transparent substrate 110 to connect the first transparent electrode 120 to the first electrode wiring 130 (see FIGS. 3 and 4). Herein, the conductive via 140 is preferably made of a material having high electromigration resistance in order to prevent electromigration. The material of the conductive via 140 is not specifically limited but may be made of gold (Au), platinum (Pt), carbons, or a mixture thereof. At this time, the carbons include carbon nano tube (CNT) or carbon nano fiber (CNF). Further, the conductive via 140 may be manufactured in a paste form to be formed on the penetration hole 145 of the first transparent substrate 110.

Meanwhile, when the first transparent electrode 120 is made of a conductive polymer including poly-3,4-ethylenedioxythiophene/polystyrenesulfonate (PEDOT/PSS), polyaniline, polyacetylene, polyphenylenevinylene, or the like, if the first transparent electrode 120 directly contacts the first electrode wiring 130, an insulating compound is generated in addition to the electromigration. However, the first transparent electrode 120 is connected to the first electrode wiring 130 through the conductive via 140, thereby making it possible to prevent the insulating compound from being generated in the first transparent electrode 120.

In addition, the capacitive touch panel 100 according to the present embodiment forms the first electrode wiring 130 on the opposite surface of the first transparent electrode 120 (based on the first transparent substrate 110) by adopting the conductive via 140, thereby making it possible to maximize the area of the first transparent electrode 120. Therefore, the area of the active region through which a user's touch is sensed can be expanded at maximum, as described above.

The second transparent substrate 150 includes the second transparent electrode 160 formed on one surface, wherein the material of the second transparent substrate 150 is not particularly limited as in the first transparent substrate 110, and may include polyethyleneterephthalate (PET), polycarbonate (PC), polymethylmethacrylate (PMMA), polyethylenenaphthalate (PEN), polyethersulfone (PES), cyclic olefin copolymer (COC), triacetylcellulose (TAC) film, polyvinyl alcohol (PVA) film, polyimide (PI) film, polystyrene (PS), biaxially oriented polystyrene (BOPS; containing K resin), glass or tempered glass and so on.

When there is a user's touch, the second transparent electrode 160 serves to generate a signal together with the first transparent electrode 120 to allow the controller to recognize coordinates. The second transparent electrode 160 is formed on one surface of the second transparent substrate 150 to be disposed to be opposite to the other surface of the first transparent substrate 110 (opposite surface of one surface of the first transparent substrate 110 on which the first transparent electrode 120 is formed). Herein, the second transparent electrode 160 may be made of indium tin oxide (ITO) or a conductive polymer similar to the first transparent electrode 120. Before forming the second transparent electrode 160 on one surface of the second transparent substrate 150, it is preferable to perform a high frequency treatment or a primer treatment on the surface of the second transparent substrate 150 in order to improve adhesion.

The second electrode wiring 170, which serves to transfer an electrical signal between the second transparent electrode 160 and the controller, is connected to the second transparent electrode 160. Herein, the second electrode wiring 170 may be made of silver (Ag) paste or organic Ag, similar to the first electrode wiring 130. At this time, the second electrode wiring 170 may be formed using a silk screen method, a gravure printing method, an ink-jet printing method or the like. Meanwhile, even though the second electrode wiring 170 is shown to be connected to both ends of the second transparent electrode 160, it is not always limited thereto but may also be connected to one end of the second transparent electrode 160 according to the scheme of the touch panel.

The adhesive layer 180 adheres the other surface of the first transparent substrate 110 to the second transparent electrode 160 to support them so that the other surface of the first transparent substrate 110 is opposite to the second transparent electrode 160. Herein, the material of the adhesive layer 180 is not particularly limited, but it is preferable to use an optical clear adhesive (OCA) in order to prevent visibility from being degraded.

Meanwhile, in order to transfer the electrical signals generated from the first transparent electrode 120 and the second transparent electrode 160 to the controller provided outside the touch panel, a flexible printed cable 190 is provided between the first electrode wiring 130 and the second electrode wiring 170 (see FIGS. 2, 3, and 5). Herein, one surface of the flexible printed cable 190 is connected to the first electrode wiring 130 and the other surface thereof is connected to the second electrode wiring 170 using an anisotropic conductive adhesive (ACA) or an anisotropic conductive film (ACF).

In addition, in the capacitive touch panel 100 according to the present embodiment, the first transparent electrode 120 is disposed on the upper side of the first transparent substrate 110, unlike the capacitive touch panel according to the prior art. Therefore, in order to protect the exposed first transparent electrode 120, it is preferable that the capacitive touch panel 100 according to the present embodiment includes a protective layer 195 coating the first transparent electrode 120. Finally, the first transparent electrode 120 senses a user's touch through the protective layer 195. Meanwhile, the protective layer 195 is not specifically limited, but may be formed of a hard coating film or the like.

According to the present invention, the transparent electrode is connected to the electrode wiring through the conductive via to prevent electromigration (EM), thereby making it possible to prevent the performance of the touch panel from being degraded and the life span thereof from being shortened.

In addition, according to the present invention, the transparent electrode is disposed on the upper side of the transparent substrate, thereby making it possible to improve sensitivity of the transparent electrode.

In addition, according to the present invention, the electrode wiring is formed not on the same surface of the transparent electrode but on the opposite surface of the transparent electrode on the basis of the transparent substrate to correspond to both ends of the transparent electrode with the edges of the transparent substrate, thereby making it possible to maximally expand the area of the active region that senses a user's touch.

Although the preferred embodiments of the present invention have been disclosed for illustrative purposes, they are for specifically explaining a capacitive touch panel according to the present invention are not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A capacitive touch panel, comprising:
a first transparent electrode formed on one surface of a first transparent substrate;
a first electrode wiring formed on the other surface of the first transparent substrate;
a conductive via penetrating through the first transparent substrate to connect the first transparent electrode to the first electrode wiring;
a second transparent electrode formed on one surface of a second transparent substrate;
a second electrode wiring connected to the second transparent electrode; and
an adhesive layer formed between the other surface of the first transparent substrate and the second transparent electrode so that the other surface of the first transparent substrate is opposite to the second transparent electrode.

2. The capacitive touch panel as set forth in claim 1, further comprising:
a flexible printed cable of which one surface is connected to the first electrode wiring and the other surface is connected to the second electrode wiring.

3. The capacitive touch panel as set forth in claim 1, wherein the conductive via is made of gold (Au), platinum (Pt), carbons, or a mixture thereof.

4. The capacitive touch panel as set forth in claim 3, wherein the carbons include a carbon nano tube or a carbon nano fiber.

5. The capacitive touch panel as set forth in claim 1, wherein the first transparent electrode is made of a conductive polymer.

6. The capacitive touch panel as set forth in claim 5, wherein the conductive polymer includes poly-3,4-ethylenedioxythiophene/polystyrenesulfonate (PEDOT/PSS), polyaniline, polyacetylene, or polyphenylenevinylene.

7. The capacitive touch panel as set forth in claim 1, wherein both ends of the first transparent electrode correspond to the edges of the first transparent substrate.

8. The capacitive touch panel as set forth in claim 1, further comprising:
a protective layer coating the first transparent electrode.
